(19) United States
(12) Patent Application Publication
(10) Pub. No.: US 2002/0161854 A1
(43) Pub. Date: Oct. 31, 2002

(54) Digital city

(76) Inventor: Warren Wojcik, Broadus, MT (US)

Correspondence Address: Warren Wojcik, RR 59, Broadus, MT, 59317, US

(21) Appl. No.: 10/090,511

(22) Filed: Mar. 4, 2002

Related U.S. Application Data
(60) Provisional application No. 60/273,960, filed on Mar. 6, 2001.
(60) Provisional application No. 60/292,717, filed on May 21, 2001.

(51) Int. Cl. G06F 15/16

(52) U.S. Cl. 709/218

(57) ABSTRACT

The digital city has real property borders (10), government (14), business (15), resident (16), and television (17) directories. A computer and communication center (20) is built containing and connecting the directories. The entire community is uploaded into the directories creating a virtual public network.

### CROSS-REFERENCE TO RELATED APPLICATIONS

This application is entitled to the benefit of Provisional Patent Applications Ser. No. 60/273,960 filed Mar. 03, 2001 and No. 60/292,717 filed Jun. 05, 2001.

### BACKGROUND

1. Field of Invention

This invention relates to raising computer and communications functionality to a civic community level creating a virtual public network.

2. Decsciption of Prior Art

Public computer, telephone, and television communications are global communication systems. They do not exhibit any particular shape. In general, they resemble population and economy concentrations that developed over the centuries. A ‘brilliant cloud’ is a name given to describe the new mountains of digitized communications.

Internet technology is still at the dot corn stage of development. With it, the entire world is available. There are no borders or order and that is a problem. How to fit the entire world's advertising on one dot corn site? Or, how can your advertising be found in a global borderless community. Most local businesses find Internet advertising and communications useless. The Internet is dominated by a few dot com sites such as AOL and MSN. They are cluttered with advertising. It is difficult to find things and know where you are on the world wide web. There is no structure to navigate and searching is tunnel vision and confusing.

The first Internet systems were virtual private networks. Virtual private networks resemble this invention. Being connected to a virtual private network one has audio and visual communications as well as computer capabilities. These virtual private networks do have shape. The shape serves the purpose of the private network. The shape is a functional necessity of a virtual private network.

### SUMMARY

This invention is about going digital as a civic community creating a virtual public network. This is an important leap forward at this time because we have already reached the step where we have audio and video communication and computer functions when we are connected to a virtual private network. This invention leads us as civic communities with real property borders into a virtual public network where telephone, television, and computer functions can merge. And, while achieving these technical advances, this invention strengthens our civic framework.

### OBJECTS AND ADVANTAGES

Accordingly, some objects and advantages of my invention are:

1. A virtual public network of civic communities with borders breaks up the dot corn global borderless community. This first step makes local Internet advertising and communications much more useful.

2. This invention strengthens our civic framework.

Further objects and advantages of my invention will become apparent from a consideration of the drawings and ensuing description.

### DRAWING FIGURES

FIG. 1 is an isometric view of a digital city.

FIG. 2 is a top view showing four directories converging to a central location.

FIG. 3 is a schematic view showing how existing computer and communication networks connect with digital cities.

FIG. 4 is an isolated view of digital city creative basis.

FIG. 5 is an example showing a display screen connected to the digital city computer and communication center.

### DESCRIPTION

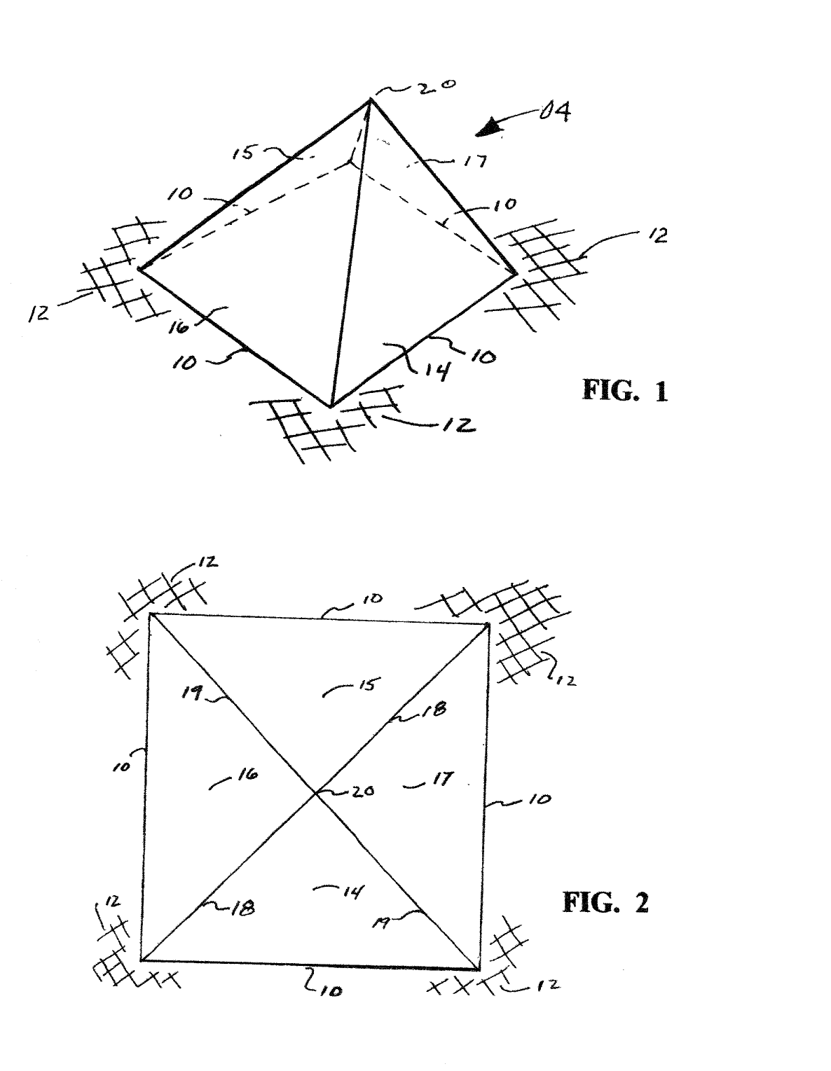

FIG. 1 is a perspective view of one digital city site. A digital city represents real community life 04 with real border's 10 on real Earth 12. Local government defines the border's 10 on real Earth 12. A digital city site is defined as a city, cities and county combination, a Native American nation, a borough, a district, a town, a defined geographical area with a sense of community and having an elected government.

FIG. 2 is a top view showing four facets representing four directories within border's 10; a business and organizations directory 15, a government directory 14, a resident directory 16, a television and culture directory 17. This invention's specifically designed communication and computer center 20 begins as the civic community's 04 web site home page 20. It contains all four directories, connects all four directories, and connects all four directories with all other computer and communications networks. It connects to and provides all directory locations with audio and visual communication, computer program services, and a virtual location seven days a week and 24 hours a day. Web site 20 is the foundation design from which to build a computer and communication center 20 in each civic community 04.

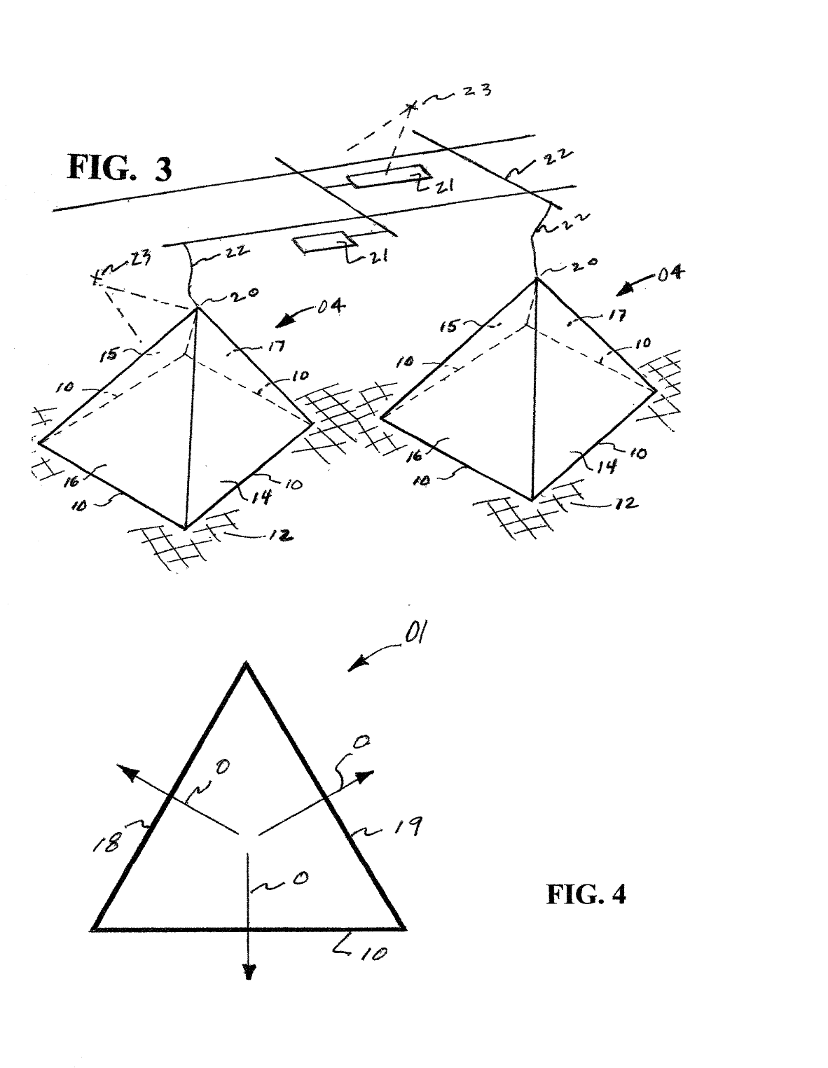

FIG. 3 is a perspective view of the digital city in relationship with existing communication networks. The digital city computer and communications center 20 is linked via hardwire 22 or wireless 23 to its directory locations, to other digital city computer and communications centers 20, and anywhere on communications networks 22 and 23. All types of virtual private networks 21, and telephone and television communication networks on 22 and 23 connect at site 20.

FIG. 4 is a schematic view of a directory and an individual. This schematic view shows the creative basis of digital city. Ownership 10, work 18, and results 19 are considered creative aspects, inherent 0 of each individual 01. It is further reasoned that government is generally an outgrowth or steering mechanism of our collective business lives and television is generally an outgrowth or steering mechanism of our collective personal lives.

More evidence shows these inherent creative aspects in Self, government, and economy. Notice the straight line similarities:

| | | | |
|---|---|---|---|
| Self; | Ownership 10, | Work 18, | Results 19, |
| USA; | Executive 10, | Congress 18, | Judiciary 19, |
| Economy; | Capital 10, | Production 18, | Sales 19. |

Operation

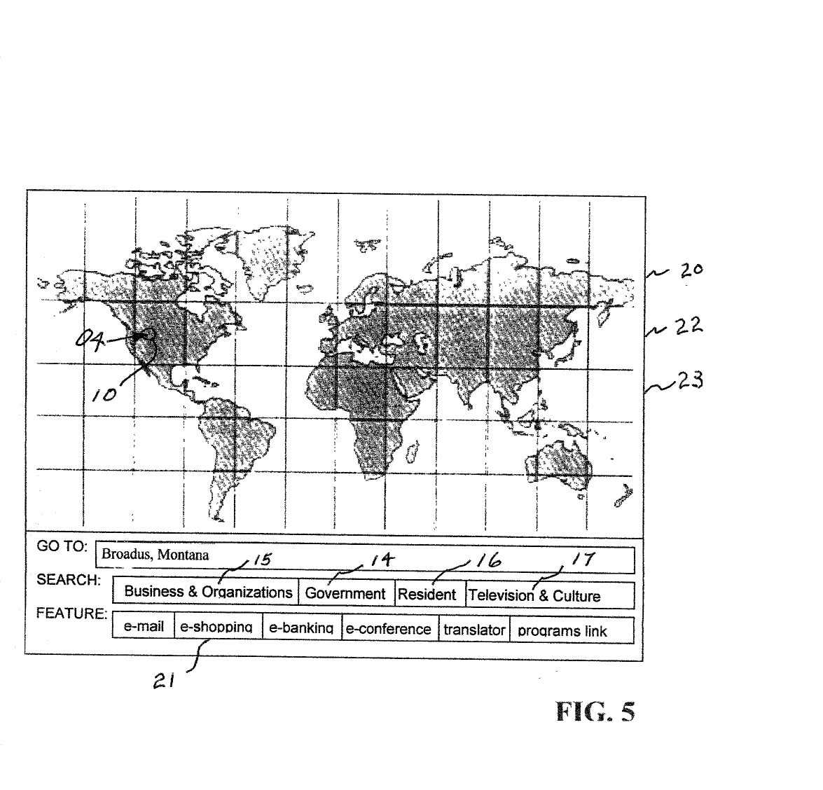

FIG. 5 is an example of a display screen from a digital city computer and communication center 20. A digital city begins as a web site placed in the Internet following the specific model as set forth in this invention. The computer and communication center 20 is preferably built in its real community 04. The entire community is uploaded to government 14, or business 15, or resident 16, or television 17 directories. Telephone and television communications are connected 22, 23. All types of virtual private networks 21 are connected at 20 with government 14, or business 15, or resident 16, or television 17 directories.

Digital city as described above is a virtual public network of civic communities. Starting with a web site placed in the Internet following the specific model as set forth in this invention, a computer and communication center 20 is constructed within a community 04 with real borders 10. The center 20 contains government 14, business 15, resident 16, and television 17 directories. The entire community is uploaded into these directories. Each directory location is connected to center 20 and is in the virtual public network. This provides the user with audio and visual communications as well as computer program functions full time from center 20. Television and telephone communications 22 and 23 are connected and integrated. All types of virtual private networks 21 are connected and integrated.

Digital city is the first and only virtual public network. It has many positive effects:

1. It promotes economic development and civic revitalization in each community.

2. It provides the public improved audiovisual communications and computer functions.

3. It opens the Internet door to more advertising within each community and between communities.

4. It stimulates the global economy. It creates demand for community computer and communication centers and improved directory location devices. It creates demand for more hardwire and wireless communications installations.

6. It is an improved orientation for big business and governments as their virtual private networks are connected to digital city.

### Conclusion, Ramifications, and Scope

Accordingly, the reader will see that digital city is a virtual public network built in the Internet following a specific civic community model. Digital city represents real life, real property, and real democratic exchange. It is an elevation of computer and communications technology to the civic community level and has many positive effects.

It is a step back to find civility and our source of creativity. And, with civility and our source of creativity clearly defined, this allows us to move ahead with communications and computer technology. Digital City is a virtual public network. It is a public computer. It evolved from our political and economic history. It is no coincidence, as necessity is the mother of invention, that the Digital City public computer can now be attached to business, government and personal computers, television, and all other communication devices.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A digital civic community comprising:
(a) local government defining borders;
(b) a computer and communication center containing a government directory, a business directory, and a resident directory; and
(c) means connecting said directories.

2. A digital civic community comprising:
(a) local government defining borders;
(b) a computer and communication center containing a government directory, a business directory, a resident directory, and a television directory; and
(c) means connecting said directories.

3. A digital civic community as defined by claim 2 in which said means connecting said directories includes connecting telephone and television communications and all computer virtual private networks.

4. A digital civic community as defined by claim 2 in which said computer and communication center provides each directory location with audiovisual communication and computer functions as fill time service in a virtual public network.

5. A method of making a digital civic community comprising the steps of:
(a) placing a web site in the Internet containing and connecting a government directory, a business directory, a resident directory, and a television directory;
(b) build a computer and communication center in a civic community containing and connecting said directories; and
(c) upload the entire civic community into said directories.
